(19) United States
(12) Patent Application Publication
(10) Pub. No.: US 2006/0103729 A1
(43) Pub. Date: May 18, 2006

(54) Computer-based image capture system

(76) Inventors: James Burns, Purdys, NY (US); Rangarajan Krishnamurthi, Ashland, MA (US)

Correspondence Address: MILDE & HOFFBERG, LLP, 10 BANK STREET, SUITE 460, WHITE PLAINS, NY, 10606, US

(21) Appl. No.: 11/301,493

(22) Filed: Dec. 13, 2005

Related U.S. Application Data
(63) Continuation-in-part of application No. 11/010,925, filed on Dec. 13, 2004, now abandoned.
(60) Provisional application No. 60/529,035, filed on Dec. 12, 2003.

(51) Int. Cl. H04N 5/225

(52) U.S. Cl. 348/207.1

(57) ABSTRACT

A system is disclosed for capturing, displaying, annotating, cataloging and storing still and video images using a programmed digital computer. The computer has an input port for receiving digital images, a display screen, a keyboard, a cursor pointing device and a digital storage medium. The computer is programmed to carry out the following tasks: (a) Capture selected images and video clips in response to a capture input to the computer by the user. The computer displays such captured images on the display screen and allows the user to insert text and drawing annotations on the images. (b) Export user-selected ones of the stored images into a word processing document template for creating a report. (c) Store selected ones of the captured images and word processed reports in association with an identity name input to the computer by the user. (d) Create a directory of stored images in accordance with the identity name.

### CROSS-REFERENCE TO RELATED APPLICATIONS

This application is a continuation-in-part of the U.S. patent application Ser. No. 11/010,925 filed Dec. 13, 2004, entitled “COMPUTER BASED IMAGE CAPTURE SYSTEM WITH FOOT-SWITCH, NETWORK SUPPORT AND STREAMING VIDEO” which, in turn, claims priority from the U.S. Provisional Patent Application Ser. No. 60/529,035, filed Dec. 12, 2003, entitled “SYSTEM FOR CAPTURING AND ANNOTATING STILL AND VIDEO IMAGES FOR MEDICAL REPORTS”.

### BACKGROUND OF THE INVENTION

The present invention relates to a computer system for capturing, storing, displaying and modifying a plurality of digital images (still and/or video images) and adding text thereto if desired. The system of the present invention is particularly useful in creating records and/or reports containing such images and for archival storage and/or transmission of such records and/or reports to another location.

The medical imaging art includes a number of different types of camera systems for capturing and archiving still and video images. FIG. 1 shows a typical medical imaging system wherein a single source 10 of still or video images (e.g. still or video camera, endoscope or the like) supplies an analog image signal to one or more devices such as a display 12, a printer 14 and/or an “image capture system” 16 which includes an analog to digital converter and a stored program computer with non-volatile storage.

There are quite a number of disadvantages to this presently known approach. They include:

1. The equipment—particularly the software—cost is high and not easily affordable to small medical practices.

2. There is no convenient way of making the images and video available for viewing in the doctor's office after the procedure is complete.

3. Traditional media cannot readily interface with a hospital or clinic's computer network for preparing reports and for archival storage.

4. Annotation capabilities are very limited in the current image-capture systems.

5. Images acquired and archived using print media, and analog storage devices such as videotape, cannot be easily emailed or used in presentations.

6. Live or captured (stored) video cannot be streamed easily over the Internet.

7. Cataloguing and filing of stored images, including video, are a manual and labor-intensive process.

8. Capturing still images and video clips, viewing captured images, cataloguing, annotation, and reporting using a Microsoft Word-based blank report templates or documents is not easily achieved in an integrated platform.

9. If live video is previewed on a dedicated television or computer monitor, it adds to the cost of equipment.

10. If still images and video are captured to individual media, such as a color printer, removable flash memory, floppy disk, CD, DVD, or videotape, the require an extra step to convert to other media.

11. If still images and/or video images captured digitally are stored as temporary files, they require additional steps and software package(s) to retrieve and/or catalogue and save the images.

12. Still images are normally printed and then manually mechanically attached to a patient report.

13. Playback, cataloguing and filing of still and video images captured on media are a manual and labor intensive process.

14. Annotation of captured still images and video clips requires additional software.

15. Electronic reporting software limits the user's ability to customize reports. Such software usually requires the user to select from a list of predefined reports.

16. Users currently using word processing software are required to transfer and insert digital images into the electronic report manually or attach hard copy images to their printed report.

17. Emailing and/or adding still images and video clips to presentations require the user to manually open the desired software applications, and then find and attach the image(s) and/or video(s).

18. Multiple devices are required to print stills, display still images, record still or video images, and display live video.

There is currently no user-friendly method for capturing still and/or video images and creating reports incorporating these images.

### SUMMARY OF THE INVENTION

A principal object of the present invention is to provide a method and apparatus for capturing, annotating and storing still and/or video images and for creating and archiving reports including these images, which overcomes one or more of the disadvantages noted above.

The present invention provides an easy to use system that includes support for VFW (Video for Windows) and provides WDM (Windows Device Manager) compatible device drivers to capture digital images (still or video) from any type of camera. The system incorporates an easy-to-use Graphic User Interface (GUI) that has pictures to illustrate actions. The system also includes a foot-pedal to capture images and video directly to an “Identity folder”. The images can then be reviewed using the system software or Reporter software from any computer on the network. All the images can be captured directly to any location set by the user, either on a local storage drive or a network server.

The system includes a computer, a keyboard, a display screen, a cursor selection device (e.g., a mouse or touch screen) and a digital storage medium. The computer is programmed to carry out the following tasks:

(a) Capture selected images and video clips in response to a capture input to the computer by the user. The computer displays such captured images on the display screen and allows the user to insert text-based annotations on the images.

(b) Store selected ones of the captured images in association with an identity name input to the computer by the user.

(c) Create a directory of stored images in accordance with the identity name.

(d) Export user-selected ones of the stored images into a word processing document template for creating a report.

### BRIEF DESCRIPTION OF THE DRAWINGS

FIG. 1 is a block diagram of an image capture system of the prior art.

FIG. 2 is a block diagram of a first preferred embodiment of the image capture system according to the present invention.

FIG. 3 is a block diagram of a second preferred embodiment of the image capture system according to the present invention.

FIG. 4, comprised of FIG. 4(a), FIG. 4(b) and 4(c), is a chart detailing the principal software components used in the first and second preferred embodiments of the present invention and a Graphical User Interface which is generated by this software.

FIG. 5 is a display screen showing the Graphic User Interface in the image capture system of the present invention.

FIG. 6 is a representation of a report template under Microsoft Word created using the image capture system of the present invention.

FIG. 7 is an representation of an image annotation screen, showing typical annotations to an image.

### DESCRIPTION OF THE PREFERRED EMBODIMENTS

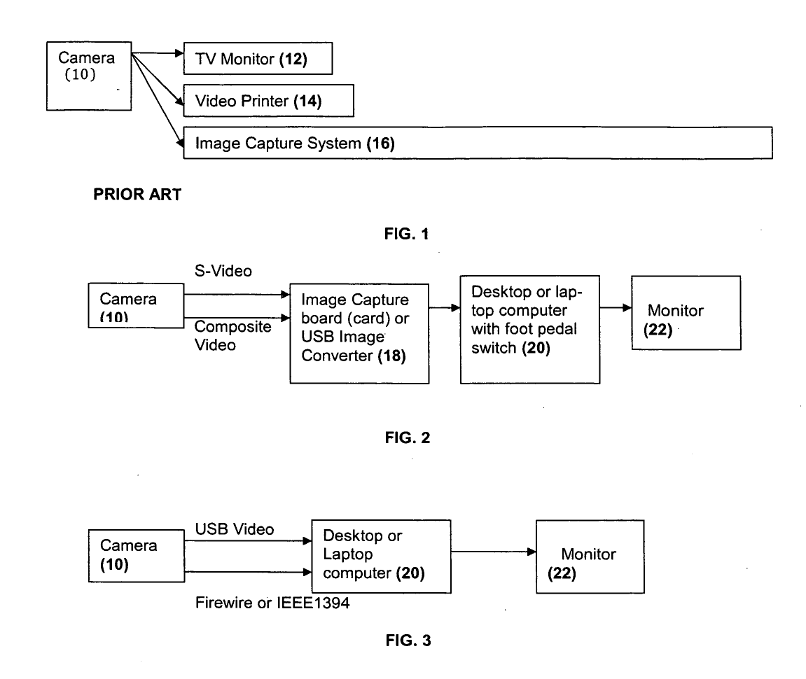

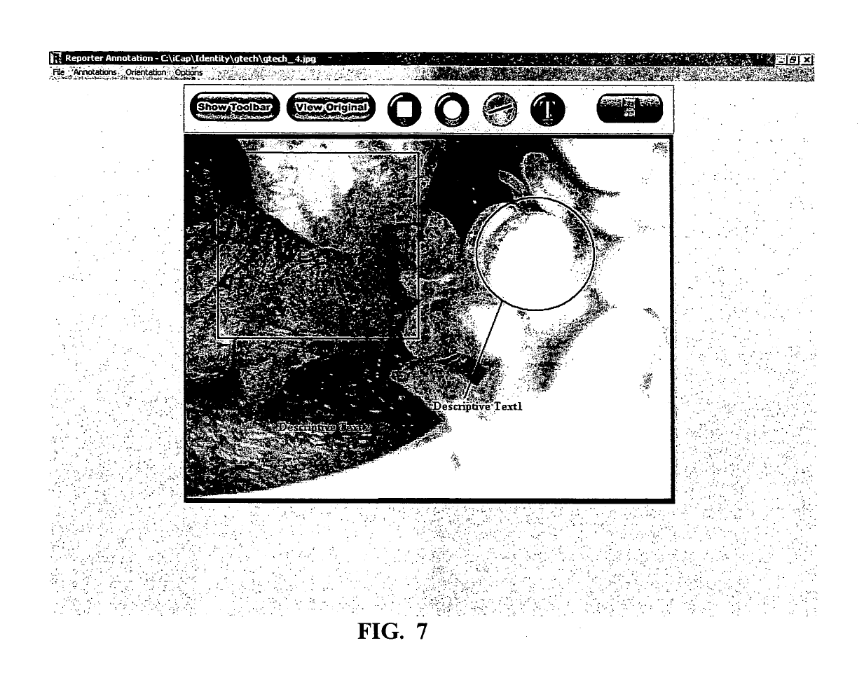

The system according to the present invention will now be described in connection with FIGS. 1-7 of the drawings. Identical elements in the various figures are designated with the same reference numerals.

As explained above, FIG. 1 shows a typical image capture system as it is known in the prior art. This system comprises a camera 10, capable of producing either still or video digital images (or both), which is connected to one or more of a display screen 12, a printer 14 and a digital computer 16 having digital, non-volatile storage. The digital computer may of course also have a display screen as well as a keyboard and mouse for user control. The computer may be, and usually is, connected to a separate printer (not shown). The computer may also be connected to a LAN and/or WAN which allows images to be transported. The computer operates with the software provided by the camera manufacturer to store and display the digital images. This software allows the computer user to select images for display and to store selected images in file folders using the keyboard and/or the mouse.

This prior art system is expensive to purchase, particularly with all of the different software packages that are required to operate and support the various separate functions that implement the capture, annotation, recordkeeping, filing, transporting, etc. of the images. In addition, when operating the system, the user must change from one applications program to another, and must be proficient in using these various applications programs.

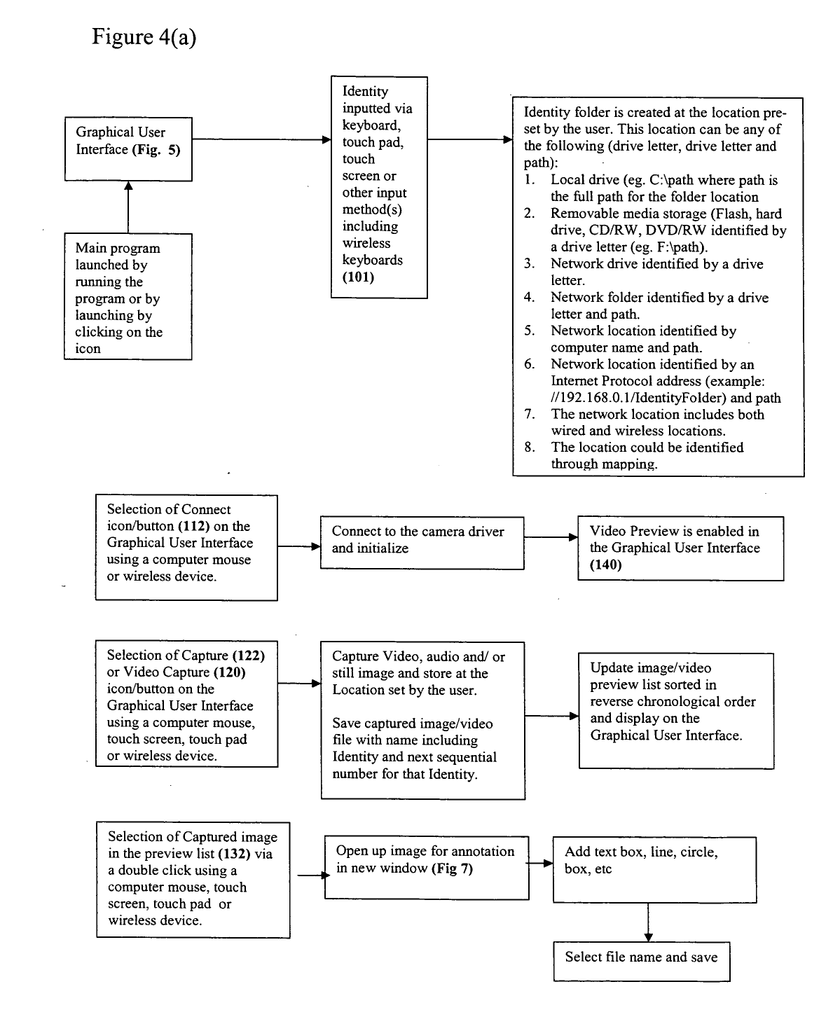

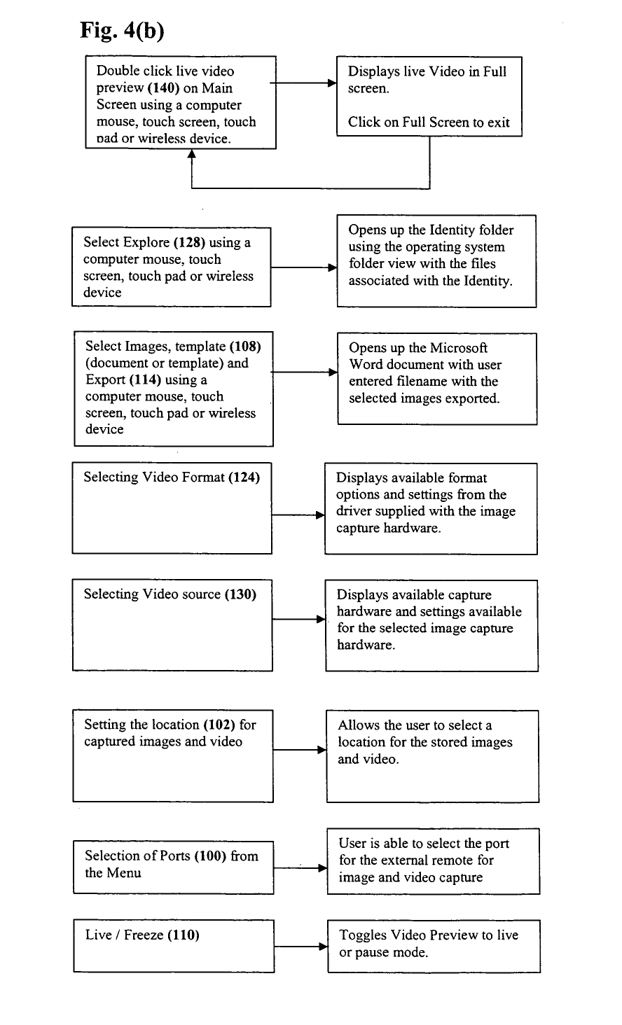

The basic system hardware according to the present invention is illustrated in FIGS. 2 and 3.

FIG. 2 illustrates a first preferred embodiment in which the camera 10 (still image camera, camcorder, television set, VCR, DVD player, endoscope or other image source) is connected to a video capture card 18, such as the “USB Videobus II”™ which is available commercially from Belkin Components, of Compton, Calif., USA. This device 18 converts analog signals from the camera 10—either 3-cable video or S-video—to a digital USB input for a desktop or laptop computer 20. The computer is loaded with F5U2208 drivers, supplied with this video capture card (e.g. via download from Belkin.com) as well as application software in accordance with the present invention and described below.

The computer 20, which receives and processes the USB input, also receives a signal from the system user which designates those camera images and/or video clips to be captured. This signal can come from any suitable signaling device, such as a computer keyboard, a mouse, a touch screen or a foot switch connected to the serial port of the computer, such as the “Treadlite II”™ which is commercially available from Linemaster Switch Corporation of Woodstock, Conn., USA.

The computer 20 is connected to a computer monitor 22, as well as to a network (LAN or WAN) and to the Internet, as desired.

FIG. 3 illustrates a second preferred embodiment in which the camera 10, that outputs digital image signals, is connected directly to the desktop or laptop computer 20 via a USB video cable or a Firewire (IEEE 1394 Standard). Otherwise, the hardware is essentially the same as that of FIG. 2.

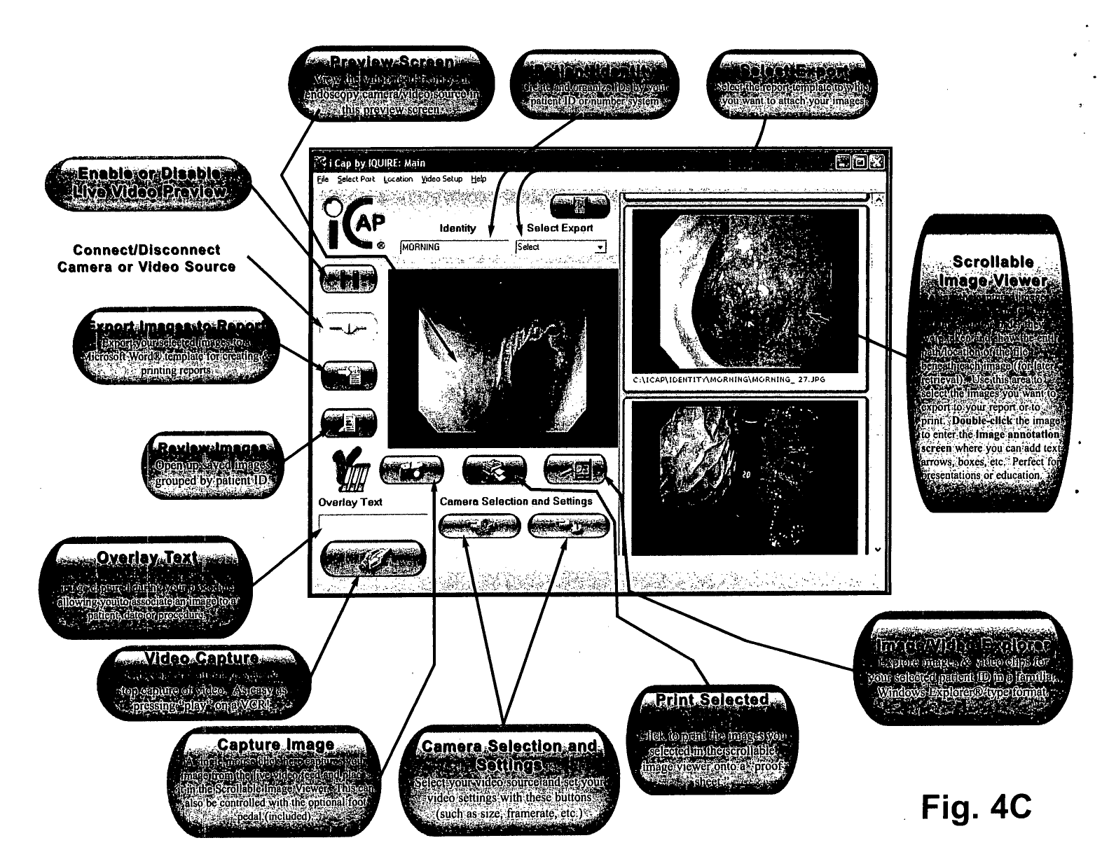

FIG. 4 is a flow chart according to the invention, detailing the operations of the software used in the computer 20 in the system of FIGS. 2 and 3. This software uses WDM or Video for Windows (VFW) image capture capabilities of Microsoft Windows to acquire the images received at the USB input. The software also utilizes Windows support for Firewire cameras or a custom driver software, referred to above, for the image capture device 18.

The acquired images, selected using the keyboard, mouse or foot switch, are saved on the local hard drive or on the network in a user selected location or a computer on the network. Once networked, the user can view the selected images and create reports by using the System Reporter program from any computer on the network.

Images (including video clips) are stored in the Identity folder and catalogued by an ID_X.YYY or ID_X.VVV where X is the image number; YYY=extension for the image file format and VVV=extension for the video file format. This number is sequential and is incremented every time a new image or video is captured. The software automatically finds the largest X and then increments it by one.

Custom Microsoft Word templates can be created for use with the system software. The system software has an “Export to Word” feature that allows the user to select images and export them directly into a template of their choice. This makes customization and report generation easy. Users can store predefined information in report templates and use the system to select the template and automatically resize and place the images into the report. The system software exports images to any proprietary templates created by the end user. This allows them to use a template of their choice for reporting.

When a Patient ID is entered, for example, the software automatically searches the default Identity folder for that Patient ID. Once a match is found, it automatically displays a thumbnail view of the captured images and video clips for that Identity. If the entered Identity does not exist, it creates a new folder for that Identity.

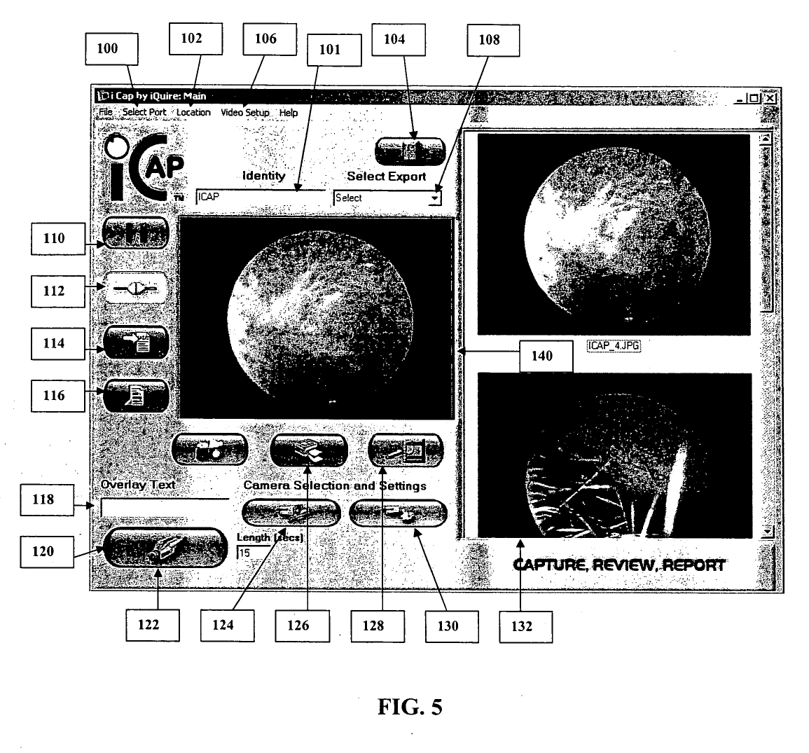

The system software uses a Graphical User Interface (GUI), shown in FIG. 5, where actions are indicated by buttons instead of words. The buttons are self-explanatory and the user interface has been designed for simplicity and ease of use. The Graphical User Interface makes it simpler for non-English speaking users to train on the use of the software and the system.

Still images and video clips can be captured using the foot-pedal that interfaces with the serial port of the computer 20. The software can also use the serial interface to respond to button presses on the cameras or endoscopes.

FIG. 4(a) illustrates the method used in the application software for the computer 20, running the Microsoft Windows operating system. The main software program generates the Graphical User Interface shown in FIG. 5. The user clicks on the box entitled “enter identity” and types in the name of a person (for example) which becomes the name of an identity folder. This folder is then created at a location which has been preset by the user either locally or in a network. For example, the local disk drive would be designated as c:\path, where path is the full path for the folder location.

Thereafter, the image capture and annotation process proceeds in three steps:

1. First the user clicks button 112 (FIG. 5) the “connect to camera” driver for the default camera selection. If another camera is desired, the user clicks on the “video setup” drop down menu to connect to another camera driver and initialize the system.

2. Thereafter, the user clicks on either the camera capture image button 122 or the video capture button 120 to capture the live image shown on the screen area 140 using the mouse or touch screen or the user presses the foot pedal. The still or video image is then captured and stored at the location previously set by the user in the current folder having the identity name. Successive images and video strips are given sequential numbers. These captured images are also displayed in the thumbnail image screen area 132.

3. Finally, the user may annotate the captured image 132 by simply double clicking on the thumbnail of the image they wish to annotate.

FIG. 4(b) illustrates a number of features that may be accessed using the Graphical User Interface. These features correspond to the GUI buttons, as indicated by the respective reference numerals.

The main display screen of the Graphic User Interface (GUI) is shown in FIG. 5. This display screen provides control over all of the features and capabilities of the system. Set forth below is a list of the various buttons and drop-down menus shown on the screen associated with their reference numerals as indicated in the drawing:

100. Assign the port into which the foot pedal switch is plugged.

101. Field for entering the “identity” to be assigned to the file folder.

102. Set network location of “Identity Folder” (for network installations).

104. Exit the program.

106. Set up Camera and Video.

108. Select the template to which images are to be sent when the “Export to Word” button is clicked.

110. Freeze and unfreeze video.

112. Connect or disconnect to and from live camera feed.

114. Export to Word.

116. Recall an Identity for review.

118. Add overlay text to images.

120. Capture Video.

122. Capture Stills: Select to capture images. The foot pedal switch may be used to capture images.

124. Video Format.

126. Print: Select up to 4 images for printing.

128. Explore images and Video.

130. Video Source.

132. Click on an image to open it in the Annotation Screen.

140. Image preview window. A double click on this window displays a full screen live image.

The Graphic User Interface provides:

A. A single entry of an identifier used to file and save captured or imported files.

B. A single entry of overlay text or watermark on previewed and captured images.

C. Selection using an input device such as computer mouse for access by selecting an icon/image for

1. Viewing of a live image,

2. Pausing or un-pausing (freeze or live) of live video,

3. Capturing still images, saving under a pre-defined Identifier and instant preview of image thumbnails for this Identity,

4. Start and stop of video recording with automatic image thumbnail of video in the preview list,

5. Access to view catalog of image and video files,

6. Access to external video editing software,

7. Image export and direct placement of image(s) to a user selected document or template in a word processing application,

8. Image export to a proof sheet for printing,

9. Image and video export to a presentation software,

10. Image and video export to default email application

11. Access to a list of available report templates or documents for image export,

12. Access to video device settings,

13. Access to video format settings,

14. Access to Windows Explorer for a selected Identifier,

15. Exiting the program,

16. Scrolling of captured images,

17. Access to a help menu,

18. Access to trigger port configuration,

19. Access to change storage location of files,

20. Access to import images and video from removable media,

21. Access to full screen video,

22. Replay of captured video files from the preview list of captured video and images, and

23. Access to annotation screen by double clicking the image from the preview list.

The software according to the invention enables the images to be annotated. Double clicking on an image opens the image for annotation and it is saved after the annotation is complete.

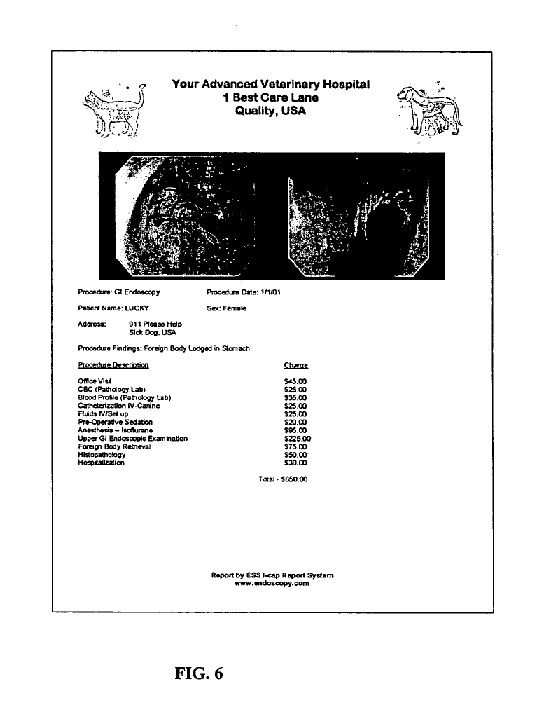

A sample report template is shown in FIG. 6. The template is highly customizable for each individual user. This offers the user the ability to create custom templates targeted to their industry specific requirements. The system opens the template selected from the drop down menu in the GUI and exports (inserts) images to the selected customer templates and/or documents in the template directory. The system, with the software, is extremely flexible and easy to use, allowing:

1. Capture of still images and video clips on a laptop or desktop computer without the need for expensive equipment.

2. Capture of still images and video clips from any camera system.

3. Live video display on the computer display screen.

4. Capture of still images and video clips on the computer for storage on the hard drive or other media.

5. Making the images available for viewing on the network.

6. Offering annotation and reporting capabilities.

7. The use of customizable, pre-stored Microsoft Word templates or user-created Microsoft Word templates to create reports.

8. Emailing still images and video clips.

9. Use of images in presentations or documentation.

10. Capture of still images and video clips using a remote trigger such as foot pedal switch during a medical procedure.

The system according to the invention can be applied to any industry in which there is a need to provide documentation which includes images, such as Medical, Insurance, Automotive, Repair/Service, Real Estate, Defense, Aviation, etc.

The system allows the user to select the device he/she would like to use to capture images. Since image capture capabilities vary by device, the system software utilizes several methods to facilitate capture. When a device is selected, the software depends on the drivers for that device the user selected to enable the device and configure it for use. For example, if a user selects the driver for a USB camera, then that unit becomes the source for video and images in the system software. The software also utilizes Windows operating system support for Firewire or IEEE 1394 video devices, Bluetooth and wireless technologies, if this type of device is selected by the user. In most cases the system software will use the custom drivers supplied with the hardware from the manufacturer. This allows the system to interface with a multitude of devices including, but not limited to, one or more image capture boards and USB video converters.

There has thus been shown and described a novel computer-based image capture system which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. A computer system for storing, displaying and modifying a plurality of images and text, said system comprising (1) a stored program digital computer having an input port for receiving digital images, (2) a display screen coupled to the computer, (3) a keyboard coupled to the computer, (4) a cursor pointing device coupled to the computer, and (5) a digital storage medium coupled to the computer for storing images and text, said computer being programmed to carry out the steps of:
(a) receiving and storing an identity name input to the computer by the user using the keyboard;
(b) receiving images input to the computer;
(c) receiving an image capture signal input to the computer by the user identifying a selected image;
(d) displaying the selected images on the display screen;
(e) receiving drawing and text annotations by the user using the keyboard for entering text and using the cursor pointing device for entering the position of the text and creating a drawing on the displayed image;
(f) storing said annotated images in association with the identity name and a consecutive image number assigned by the computer.

2. The system defined in claim 1, wherein the computer is programmed to carry out the further steps of:
(g) providing a word processing template for a report in the computer;
(h) exporting at least one user-selected annotated stored image into the word processing document template to create a report;
(i) storing the word processing report with the selected annotated image in a folder designated by the identifying name.

3. The system defined in claim 2, wherein the computer is further programmed to carry out the step of transmitting the stored word processing report with the selected annotated image to another computer.

4. The system defined in claim 2, wherein the computer is further programmed to carry out the step of creating a directory of stored images and reports in accordance with the identity names.
